(19) United States
(12) Patent Application Publication
(10) Pub. No.: US 2006/0118002 A1
(43) Pub. Date: Jun. 8, 2006

(54) Organoclay composition containing quat mixtures

(75) Inventors: Alan Steinmetz, Louisville, KY (US); Wayne Mattingly, Louisville, KY (US)

Correspondence Address: SUD-CHEMIE INC., 1600 WEST HILL STREET, LOUISVILLE, KY, 40210, US

(73) Assignee: Sud-Chemie Inc.

(21) Appl. No.: 11/004,203

(22) Filed: Dec. 3, 2004

(51) Int. Cl. C09C 1/00

(52) U.S. Cl. 106/416

(57) ABSTRACT

The present development an improved organoclay composition comprising a mixture of quaternary ammonium compounds, wherein varying ratios of dimethyl dialkyl ammonium compounds and trimethyl monoalkyl ammonium compounds are reacted with smectite clay. It has been surprisingly observed that using a mixture of these quaternary ammonium compounds results in an organoclay that has a lower organic content than conventional organoclays, but that maintains the ability to be filtered during the manufacturing process and that can be effectively dispersed in a non-aqueous system.

### CROSS-REFERENCE TO RELATED APPLICATIONS

No prior related applications.

### BACKGROUND

The present development relates to an improved organoclay composition for use in organic systems, wherein the organoclay composition exhibits improved efficiency while maintaining the ability to be readily dispersed. Specifically, the organoclay composition comprises a mixture of quaternary ammonium compounds, wherein varying ratios of dimethyl, dialkyl ammonium compounds and trimethyl, monoalkyl ammonium compounds are reacted with smectite clay. The resulting organoclays exhibit improved rheological properties in organic applications, such as lubricating grease and solvent borne paints, as compared to organoclays of the prior art.

It is well known in the art that organophilic clays, or organoclays, can be formed by allowing a clay to ion exchange with cationic organic compounds. Specifically, organic compounds which contain a cation react by ion exchange with clays having platelets in a negative layer-lattice and having exchangeable cations. As taught in the prior art, if the organic cation contains at least one alkyl group having at least 10 carbon atoms, the resulting modified clay may be used to modify the theological properties of organic liquids, such as are used in grease products and organic solvent-based paints. However, in order for the organophilic clay to be an effective rheological agent, the organophilic clay must be thoroughly dispersed in the liquid.

The prior art teaches a number of methods of improving the dispersion of organophilic clays in organic solvents. For example, the organophilic clay may include polar activators, dispersants, dispersion aids, solvating agents, or the like, such as acetone, methanol/water, ethanol/water, propylene carbonate, acetonylacetone, diacetone alcohol, dimethyl formamide, and gamma-butyl lactone, which are added along with the organophilic clay to the organic liquid. Alternatively, the organophilic clay can be preactivated by blending the clay with neopentyl glycol, 2-methyl-2-propanol, erythritol, monopalmitate glycol, phthalide, 3-hydroxy-4-methoxy benzaldehyde, 4-benzyloxypropiophenone, triethyl citrate, 2-phenoxy-ethanol, 1-phenyl-1,2-ethanediol, nitrobenzyl alcohol, 1,6-hexanediol, castor oil, nitrophenethyl alcohol, finely divided silica, amide waxes or a mixture of an amide wax and glyceryl tri-12-hydroxystearate. Exposing the organophilic clay to shearing conditions also enhances dispersibility because it is believed that such physical treatments deagglomerate the clay particles.

However, the prior art methods for modifying organophilic clays still fall short of producing a clay that has optimal efficiency and stability, particularly to the degree needed for lubricating grease and solvent borne paints.

### SUMMARY OF THE INVENTION

The present development is an improved organoclay composition comprising a mixture of quaternary ammonium compounds, wherein varying ratios of dimethyl, dialkyl ammonium compounds and trimethyl, monoalkyl ammonium compounds are reacted with smectite clay. It has been surprisingly observed that using a mixture of quaternary ammonium compounds results in an organoclay that has a lower organic content than conventional organoclays, but that maintains the ability to be filtered during the manufacturing process. These reduced-organic organoclays maintain the ability to be dispersed in their end-use applications resulting in improved Theological performance. Lowering the percent-by-weight of organic content allows for the introduction of more clay platelets on a pound-for-pound basis when compared to currently available commercial organoclays. The resulting organoclays are particularly useful in products requiring a relatively high clay platelet concentration, such as lubricating grease and solvent borne paints.

### DETAILED DESCRIPTION OF THE PREFERRED EMBODIMENT

The organoclay composition of the present invention comprises a mixture of quaternary ammonium compounds, wherein varying ratios of dimethyl, dialkyl ammonium compounds and trimethyl, monoalkyl ammonium compounds are reacted with smectite-type clay. By using this mixture of relatively low molecular weight quaternary ammonium compounds, it is believed that the resulting organoclay has essentially all its available exchange sites satisfied. Further, the loss on ignition (“LOI”) of the organoclay is reduced, wherein LOI indicates the level of organic material retained on a smectite-type clay after reaction with an organic cation and organic anion, if present, as disclosed in U.S. Pat. No. 4,240,951. Low LOI organoclays are generally known in the art to be the most suitable organoclays for use in lubricating greases.

The smectite-type clay used in the composition can be any clay which has a cation exchange capacity of at least 75 milliequivalents per 100 grams of clay. Particularly desirable types of clays are the naturally occurring Wyoming varieties of swelling bentonites and like clays and hectorite, a swelling magnesium-lithium silicate clay.

The clays, especially the bentonite type clays, are preferably reacted with a dispersant prior to reaction with the mixture of quaternary ammonium compounds. In an exemplary embodiment, a clay slurry is prepared by dispersing raw bentonite clay in hot water to yield a total solids content of from about 4.5 wt % to about 5.5 wt %. A phosphate dispersant such as tetrasodium pyrophosphate or sodium tripolyphosphate is added along with the clay at a level of from about 1.0 wt % to about 2.0 wt % based on the weight of clay. Any non-clay impurities are then removed by passing the clay slurry through hydrocyclones followed by centrifugation. The clay dispersion is maximized by subjecting the cleaned bentonite clay slurry to steam injection and/or by passing the clay slurry through a Manton/Gaulin homogenizer set at a pressure of from about 1,000 psig to about 4,000 psig. Alternatively, the clay slurry can be prepared by methods known in the art, such as a single-stage steaming process, a double-stage steaming process, a double-stage steaming process followed by the removal of non-clay impurities, single-stage steaming process followed by passing the clay slurry through a Manton/Gaulin homogenizer, and/or double-stage steaming process followed by passing the clay slurry through a Manton/Gaulin homogenizer.

The quaternary ammonium compounds reacted with the smectite-type clays are a dimethyl, dialkyl ammonium compound (the “di-alkyl quat”) and a trimethyl, monoalkyl ammonium compound (the “mono-alkyl quat”). A representative dimethyl, dialkyl ammonium compound, without limitation, that may be used in the composition includes dimethyl dihydrogenated tallow ammonium chloride, and a representative trimethyl, monoalkyl ammonium compound, without limitation, that may be used in the composition includes trimethyl hydrogenated tallow ammonium chloride.

More specifically, the di-alkyl quat can be any compound containing two methyl substituents and two other alkyl substituents on the nitrogen atom wherein the alkyl substituents each have at least 1 carbon atoms and up to about 22 carbon atoms. The other alkyl substituents can be linear or branched alkyl groups, arylalkyl groups, such as benzyl and substituted benzyl, or aryl groups, such as phenyl and substituted phenyl. The di-alkyl quats can be represented by the structural formula (R₁)(R₂)(CH₃)₂N⁺ M⁻ wherein M is an anion, such as chloride, bromide, iodide, nitrite, nitrate, sulfate, hydroxide, C₁ to C₁₈ carboxylate and the like, and wherein R₁ and R₂ are alkyl groups containing 1 to about 22 carbon atoms, arylalkyl groups containing 7 to 22 carbon atoms, aryl.groups containing 6 to 22 carbon atoms and mixtures thereof. Preferred di-alkyl quats are those wherein R₁ and R₂ are alkyl groups having about 12 to about 22 carbon atoms, those wherein R₁ is an alkyl groups having about 12 to about 22 carbon atoms and R₂ is benzyl, or mixtures thereof. The long chain alkyl groups can be derived from naturally occurring vegetable oils, animal oils and fats or petrochemicals, including corn oil, cotton seed oil, coconut oil, soybean oil, castor oil, tallow oil and alpha olefins. A particularly useful long chain alkyl group is derived from hydrogenated tallow. Other alkyl groups which can be present in the di-alkyl quats are such groups as methyl, ethyl, propyl, butyl, hexyl, 2-ethylhexyl, decyl, dodecyl, lauryl, stearyl and the like. Aryl groups include phenyl and substituted phenyl. Arylalkyl groups include benzyl and substituted benzyl groups. Examples of useful di-alkyl quat are dimethyl di(hydrogenated tallow) ammonium chloride, dimethyl benzyl hydrogenated tallow ammonium chloride, and the like.

The mono-alkyl quat can be any compound containing three methyl substituents and an alkyl substituent, R, on the nitrogen atom wherein the alkyl substituent has at least 1 carbon atoms and up to about 22 carbon atoms. The alkyl substituent can be linear or branched alkyl groups, arylalkyl groups, such as benzyl and substituted benzyl, or aryl groups, such as phenyl and substituted phenyl. The mono-alkyl quats can be represented by the structural formula (R)(CH₃)₃N⁺ M⁻ wherein M is an anion, such as chloride, bromide, iodide, nitrite, nitrate, sulfate, hydroxide, C₁ to C₁₈ carboxylate and the like, wherein R is an alkyl group containing 1 to about 22 carbon atoms or an arylalkyl group containing 7 to 22 carbon atoms or an aryl group containing 6 to 22 carbon atoms. Preferred mono-alkyl quats are those wherein R is an alkyl group having about 12 to about 22 carbon atoms. The long chain alkyl groups can be derived from naturally occurring vegetable oils, animal oils and fats or petrochemicals. Examples including corn oil, cotton seed oil, coconut oil, soybean oil, castor oil, tallow oil and alpha olefins. A particularly useful long chain alkyl group is derived from hydrogenated tallow. Other alkyl groups which can be present in the mono-alkyl quats are such groups as methyl, ethyl, propyl, butyl, hexyl, 2-ethylhexyl, decyl, dodecyl, lauryl, stearyl and the like, aryl groups including phenyl and substituted phenyl, arylalkyl groups including benzyl and substituted benzyl groups.

The quaternary ammonium compounds can be added at a level to deliver from about 75 milliequivalents to about 135 milliequivalents of quat per 100 grams of clay, and the ratio of the two quaternary ammonium compounds can vary on a milliequivant weight basis from about 5 di-alkyl quat: 1 mono-alkyl quat to about 1 di-alkyl quat: 5 mono-alkyl quat. In an exemplary embodiment using dimethyl, dihydrogenated tallow alkyl, ammonium chloride for the di-alkyl quat and trimethyl, hydrogenated tallow alkyl, ammonium chloride for the mono-alkyl quat, and preparing a 3:1 di-alkyl quat to the mono-alkyl quat composition with a treatment level of from about 84 milliequivalents to about 88 milliequivalents of quat per 100 grams of clay, the treatment level of di-alkyl quat on the clay will be from about 36.1 grams to about 37.8 grams, and the treatment level of mono-alkyl quat on the clay will be from about 7.1 grams to about 7.5 grams.

The quaternary ammonium compounds can be added to the clay slurry using any method for ion-exchange known in the art. For example, the quaternary ammonium compounds can be added to the clay slurry in the form of an aqueous mixture. The quaternary ammonium aqueous mixture is prepared by diluting the di-alkyl quat in hot water to deliver a quaternary compound concentration of about 8.0 wt % to about 9.0 wt %, and then the mono-alkyl quat is slowly added to the di-alkyl quat solution until the relative ratio of the di-alkyl quat to the mono-alkyl quat is as desired. A sufficient volume of the aqueous mixture is then added to the cleaned clay slurry to deliver the desired 80 milliequivalents to about 135 milliequivalents of quat per 100 grams of clay, and the combined slurry is agitated for from about 1 hour to about 2 hours. The resulting organoclay is then separated from the water via filtration using a filter press. Spray-drying the resulting filter cake yields a free-flowing powder having a moisture content of 0.5% to about 3.0%.

The organoclay compositions derived from the reaction of dimethyl, dialkyl ammonium compounds and trimethyl, monoalkyl ammonium compounds with smectite-type clay can be used in lubricating greases. The greases comprising the organoclay compositions of the present invention demonstrate significant improvement in gelling efficiency and in stability than the greases made with organoclays of the prior art. In addition, paint systems prepared with the organoclay composition of the present invention demonstrate improvement in low-shear viscosity compared to paints made with organoclays of the prior art. The organoclay compositions of the present invention also include a statistically significant higher clay content than the organoclay compositions of the prior art.

It is understood that the composition of the organoclay and the specific processing conditions described herein may be varied within limits without exceeding the scope of this development.

What is claimed is:

1. An organoclay composition comprising a smectite-type clay reacted with dimethyl, dialkyl ammonium compounds and trimethyl, monoalkyl ammonium compounds.

2. The organoclay composition of claim 1 wherein the smectite-type clay is any clay which has a cation exchange capacity of at least 75 milliequivalents per 100 grams of clay.

3. The organoclay composition of claim 2 wherein the smectite-type clay is selected from bentonite, hectorite, swelling magnesium-lithium silicate clay or combinations thereof.

4. The organoclay composition of claim 2 wherein the smectite-type clay is reacted with a dispersant prior to reaction with the dimethyl, dialkyl ammonium compounds and the trimethyl, monoalkyl ammonium compounds.

5. The organoclay composition of claim 4 wherein the dispersant is selected from tetrasodium pyrophosphate or sodium tripolyphosphate.

6. The organoclay composition of claim 1 wherein the dimethyl, dialkyl ammonium compound is any compound represented by the structural formula (R₁)(R₂)(CH₃)₂N⁺ M⁻¹ wherein M is an anion, and wherein R₁ is a first substituent having at least 1 carbon atoms and up to about 22 carbon atoms, and R₂ is a second substituent having at least 1 carbon atoms and up to about 22 carbon atoms.

7. The organoclay composition of claim 6 wherein the first substituent is selected from the group consisting of linear alkyl groups, branched alkyl groups, arylalkyl groups, benzyl, substituted benzyl, aryl groups, phenyl, substituted phenyl, and combinations thereof.

8. The organoclay composition of claim 6 wherein the second substituent is selected from the group consisting of linear alkyl groups, branched alkyl groups, arylalkyl groups, benzyl, substituted benzyl, aryl groups, phenyl, substituted phenyl, and combinations thereof.

9. The organoclay composition of claim 6 wherein the dimethyl, dialkyl ammonium compound is dimethyl dihydrogenated tallow ammonium chloride.

10. The organoclay composition of claim 1 wherein the trimethyl, monoalkyl ammonium compound is any compound represented by the structural formula (R)(CH₃)₃N⁺ M⁻ wherein M is an anion, and wherein R is a substituent selected from the group consisting of a linear alkyl group having from 1 to about 22 carbon atoms, a branched alkyl group having from 1 to about 22 carbon atoms, an arylalkyl group having from 7 to 22 carbon atoms, benzyl, substituted benzyl, an aryl group having from 6 to 22 carbon atoms, phenyl, substituted phenyl, and combinations thereof.

11. The organoclay composition of claim 10 wherein the trimethyl, monoalkyl ammonium compound is trimethyl hydrogenated tallow ammonium chloride.

12. The organoclay composition of claim 1 wherein the dimethyl, dialkyl ammonium compounds and trimethyl, monoalkyl ammonium compounds are reacted with the clay to deliver from about 75 milliequivalents to about 135 milliequivalents of quat per 100 grams of clay, and the ratio of the dimethyl, dialkyl ammonium compound to the trimethyl, monoalkyl ammonium compound can vary on a milliequivant weight basis from about 5:1 to about 1:5.

13. The organoclay composition of claim 12 wherein the dimethyl, dialkyl ammonium compounds and trimethyl, monoalkyl ammonium compounds are reacted with the clay to deliver from about 84 milliequivalents to about 88 milliequivalents of quat per 100 grams of clay, and about a 3 to 1 dimethyl, dialkyl ammonium compound to trimethyl, monoalkyl ammonium compound ratio.

14. An organoclay composition comprising a smectite-type clay having a cation exchange capacity of at least 75 milliequivalents per 100 grams of clay, wherein the clay is reacted with a dispersant, and then the clay is reacted with a dimethyl, dialkyl ammonium compound and a trimethyl, monoalkyl ammonium compound.

15. The organoclay composition of claim 14 wherein the smectite-type clay is selected from bentonite, hectorite, swelling magnesium-lithium silicate clay or combinations thereof, and wherein the dimethyl, dialkyl ammonium compound is any compound represented by the structural formula (R₁)(R₂)(CH₃)₂N⁺ M⁻ wherein M is an anion and R₁ is a first substituent having at least 1 carbon atoms and up to about 22 carbon atoms and R₂ is a second substituent having at least 1 carbon atoms and up to about 22 carbon atoms, and wherein the trimethyl, monoalkyl ammonium compound is any compound represented by the structural formula (R)(CH₃)₃N⁺ M⁻ wherein M is an anion and R is a substituent selected from an alkyl group containing 1 to about 22 carbon atoms or an arylalkyl group containing 7 to 22 carbon atoms or an aryl group containing 6 to 22 carbon atoms.

16. The organoclay composition of claim 14 wherein the dimethyl, dialkyl ammonium compound is dimethyl dihydrogenated tallow ammonium chloride and the trimethyl, monoalkyl ammonium compound is trimethyl hydrogenated tallow ammonium chloride.

17. The organoclay composition of claim 16 wherein the dimethyl dihydrogenated tallow ammonium chloride and the trimethyl hydrogenated tallow ammonium chloride are reacted with the clay to deliver from about 84 milliequivalents to about 88 milliequivalents of quat per 100 grams of clay, and about a 3 to 1 dimethyl dihydrogenated tallow ammonium chloride to trimethyl hydrogenated tallow ammonium chloride ratio.

18. An organoclay composition prepared by the method comprising the steps:
(a) preparing a clay slurry by dispersing raw bentonite clay in hot water to yield a total solids content of from about 4.5 wt % to about 5.5 wt%;
(b) adding a phosphate dispersant selected from tetrasodium pyrophosphate or sodium tripolyphosphate to the clay slurry at a level of from about 1.0 wt % to about 2.0 wt % based on the weight of clay;
(c) removing any non-clay impurities from the slurry by passing the clay slurry through hydrocyclones followed by centrifugation;
(d) maximizing the clay dispersion by treating the centrifuged clay slurry to steam injection or by passing the clay slurry through a Manton/Gaulin homogenizer set at a pressure of from about 1,000 psig to about 4,000 psig or by treating the centrifuged clay slurry with a combination of steam injection and homogenization; and
(e) adding a dimethyl, dialkyl ammonium compound and a trimethyl, monoalkyl ammonium compound to the dispersed clay slurry by ion-exchange.

19. The organoclay composition of claim 18 wherein a powder is formed by filtering the ion-exchanged clay with a filter press to form a filter cake and then spray-drying the filter cake.

20. The organoclay composition of claim 18 wherein the dimethyl, dialkyl ammonium compound is dimethyl dihydrogenated tallow ammonium chloride and the trimethyl, monoalkyl ammonium compound is trimethyl hydrogenated tallow ammonium chloride.
